(19) United States
(12) Patent Application Publication
(10) Pub. No.: US 2016/0066649 A1
(43) Pub. Date: Mar. 10, 2016

(54) WELDED SHOE ASSEMBLY

(71) Applicant: SKYDEX Technologies, Inc., Centennial, CO (US)

(72) Inventors: Peter Foley, Castle Rock, CO (US); Jerod Dahl, Centennial, CO (US)

(21) Appl. No.: 14/821,995

(22) Filed: Aug. 10, 2015

Related U.S. Application Data
(60) Provisional application No. 62/046,281, filed on Sep. 5, 2014.

(51) Int. Cl. A43B 13/28; B29C 65/00; B29C 65/14; A43B 1/14; A43D 86/00

(52) U.S. Cl. CPC A43B 13/28; A43B 1/14; A43D 86/00; B29C 65/1403; B29C 66/828; B29K 2101/00

(57) ABSTRACT

A welded shoe assembly includes a shoe upper with a plastic surface welded to a plastic surface of a bottom unit. The welded shoe assembly is formed, in one implementation, by compressing the shoe upper and a bottom unit against one another between an electrically conductive last and an electrically conductive mold and applying an electrical signal to either the electrically conductive last and/or the electrically conductive mold.

### BACKGROUND

Shoes are conventionally made up of two main components, a shoe upper and a bottom unit. The shoe upper provides an enclosure or other mechanism to fasten a shoe to a user's foot. The bottom unit engages the shoe with the ground and provides improved durability, traction, and/or cushioning to the user's foot when used in conjunction with the shoe upper.

Conventionally, shoe uppers are lasted to bottom units using a lasting machine. More specifically, a last is inserted into the shoe upper. The last is a mechanical form that has a shape similar to that of the user's foot. The bottom unit is placed in a form and glue (e.g., urethane cement) is applied to one or both of the shoe upper and the bottom unit at an interface surface between the shoe upper and the bottom unit. The lasting machine presses the shoe upper and the bottom unit together thereby securely gluing the shoe upper to the bottom unit.

Conventional shoe lasting has several disadvantages including: requiring a specialized piece of equipment to perform the lasting process (i.e., a lasting machine); using a glue that can be toxic, must be cured over a period of time to be fully effective, and can be a point of failure; and often creating an unsightly glue line at the interface between the shoe upper and the bottom unit.

### SUMMARY

Implementations described and claimed herein address the foregoing by providing a shoe assembly including a shoe upper and a bottom unit, the bottom unit having a plastic surface welded to a plastic surface of the shoe upper.

Implementations described and claimed herein further address the foregoing by further providing a method of assembling a shoe comprising: compressing a shoe upper against a bottom unit between an electrically conductive last and an electrically conductive mold; and applying a high frequency signal to at least one of the electrically conductive last and the electrically conductive mold.

Implementations described and claimed herein further still further address the foregoing by providing a welding system that includes an electrically conductive mold and an electrically conductive last. The electrically conductive mold is sized and shaped to receive a bottom unit of a shoe assembly, and the electrically conductive last sized and shaped for insertion into a shoe upper of the shoe assembly.

Other implementations are also described and recited herein.

### BRIEF DESCRIPTION OF THE DRAWINGS

FIG. 1 is a perspective view of an example welded shoe assembly.

FIG. 2 is an exploded perspective view of an example shoe assembly including a shoe upper and a bottom unit that may be welded together using a last and welding mold.

FIG. 3 is an exploded side view of an example shoe assembly including a shoe upper and a bottom unit that may be welded together using a last and a welding mold.

FIG. 4 is a perspective view of an example welded shoe assembly during a first assembling operation.

FIG. 5 is a perspective view of an example welded shoe assembly during a second assembling operation.

FIG. 6 is a perspective view of an example welded shoe assembly during a third assembling operation.

FIG. 7 is a perspective view of an example welded shoe assembly during a fourth assembling operation.

FIG. 8 is a perspective view of an example welded shoe assembly during a fourth assembling operation.

FIG. 9 is a perspective view of an example molded structure including a number of cushioning elements suitable for integration into a bottom unit of a shoe assembly.

FIG. 10 is a top view of another example molded structure including a number of cushioning elements suitable for integration into a bottom unit of a shoe assembly.

FIG. 11 is a bottom view of another example molded structure including a number of cushioning elements suitable for integration into a bottom unit of a shoe assembly.

FIG. 12A illustrates a first stage of construction of a bottom unit during which individual void cell units are formed from individual void cells.

FIG. 12B illustrates the bottom unit of FIG. 12A during a second stage of construction in which void cell units are inserted into a dual-layer carrier.

FIG. 12C illustrates a cross-sectional elevation view of the bottom unit of FIGS. 12A and 12B.

FIG. 12D illustrates an inside top view of the bottom unit of FIGS. 12A-12C.

FIG. 13 illustrates a void cell unit between an upper layer and a lower layer of a dual-layer carrier.

FIG. 14 illustrates a void cell unit protruding through a corresponding through-hole in a single layer carrier.

FIG. 15 illustrates example operations for assembling a welded shoe assembly.

FIG. 16 is an exploded perspective view of an example shoe assembly including a shoe upper and a bottom unit that may be welded together.

FIG. 17 is an exploded side view of an example shoe assembly during a first phase of a three-dimensional welding process.

FIG. 18 is a perspective view of another example shoe assembly during another phase of a three-dimensional welding process.

FIG. 19 illustrates example operations for three-dimensional welding of a shoe assembly.

### DETAILED DESCRIPTION

Implementations disclosed herein provide a welded shoe assembly and various techniques for welding of planar and contoured plastic contact surfaces.

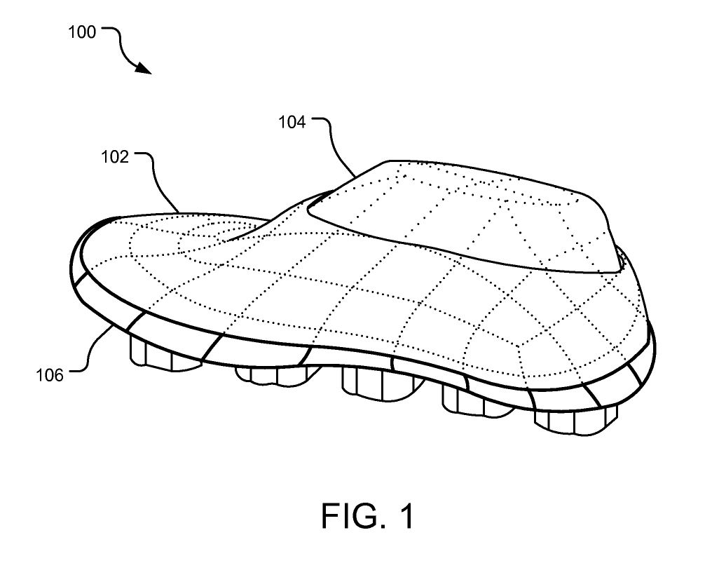

FIG. 1 is a perspective view of an example welded shoe assembly 100. The assembly 100 includes a shoe upper 102 with a last 104 inserted therein. The welded shoe assembly 100 further includes a bottom unit 106 that is welded to a lower (e.g., ground-facing) surface of the shoe upper 102. The shoe upper 102 may be constructed of one or more of a variety of materials (e.g., textiles, plastics, ethylene-vinyl acetate (eva) foam, other foams, rubber, wood, metal, etc.), but the shoe upper 102 material at the interface surface is limited to a plastic material that is readily weldable to the bottom unit 106 using a selected welding process. Suitable plastic may include both polar and non-polar plastics. Several example welding processes are discussed in detail below, although any suitable welding process is contemplated herein.

The last 104 and a corresponding mold (not shown) are conductive components and may be constructed from a variety of suitable conductive materials. As used herein, the term “conductive” refers to electrical conductivity. Limitations of the selected welding process may limit the construction material of the last 104 to materials that will withstand the selected welding process and operate in conjunction with the selected welding process (e.g., various metals such as aluminum, brass, steel, and iron). In one implementation, the last 104 is coated with (rather than formed from) a conductive material, such as a conductive tape or plating.

Conventional bottom units include eva foam, which is directly glued to shoe uppers constructed using one or more of a variety of materials (e.g., textiles, plastics, foams, wood, metal, etc.). Bottom unit 106 may also include eva foam or other construction materials (e.g., textiles, plastics, other foams, rubber, wood, metal, etc.). However, at an interface surface with the shoe upper 102, the bottom unit 106 material is also limited to a material that is readily weldable to the bottom unit 106 using the selected welding process.

In one implementation, the shoe upper 102 is welded to the bottom unit 106 using an ultrasonic welding process. During the ultrasonic welding process, the shoe upper 102 is compressed against the bottom unit 106 (e.g., between a welding mold (not shown) and the last 104) while low-amplitude, high-frequency (e.g., about 15-70 kHz) ultrasonic acoustic vibrations are applied to the shoe upper 102 and the bottom unit 106 at one or more discrete locations to create one or more solid-state welds.

In an implementation utilizing ultrasonic welding, the welding mold and/or the last 104 includes one or more sonotrodes, which are connected to one or more transducers. The transducers emit the acoustic vibration, which is directed to one or more specific locations where the shoe upper 102 and the bottom unit 106 are compressed together using the sonotrodes. The ultrasonic energy melts the point contact(s) between the shoe upper 102 and the bottom unit 106, creating welded joint(s). Ultrasonic welding is a suitable welding method for joining a variety of materials, including dissimilar materials (e.g., various plastics, fibrous composites, and some low-melting point metals). Therefore, implementations utilizing ultrasonic welding may select one or more of these suitable materials for constructing the shoe upper 102 and the bottom unit 106.

In another implementation, the shoe upper 102 is welded to the bottom unit 106 using a radio-frequency (rf) welding process (also known as high-frequency welding or dielectric sealing). The shoe upper 102 is compressed against the bottom unit 106 (e.g., between the mold and the last 104) and high-frequency (e.g., about 27 MHz) electromagnetic waves are passed between the shoe upper 102 and the bottom unit 106 through the shoe upper 102 and the bottom unit 106 at one or more discrete locations to create one or more solid-state welds.

The electromagnetic waves used in rf welding cause various dipolar materials (e.g., various plastics such as polyvinyl chloride (PVC), various polyamides (PA), various acetates, polyurethane (PU), nylon, polyethylene terephthalate (PET), ethylene vinyl acetate (EVA), polyethylene vinyl acetate (PEVA), and acrylonitrile butadiene styrene (ABS)) to soften and melt. As a result, these or other dipolar materials are used to construct the shoe upper 102 and the bottom unit 106 where the shoe upper 102 is welded to the bottom unit 106 using rf welding process to construct the welded shoe assembly 100. In still other implementations, non-polar materials are used to construct one or both of the shoe upper 102 and the bottom unit 106. For example, the herein described welding techniques may be used to weld polar plastics to non-polar plastics, polar plastics to one another, or non-polar plastics to one another.

Welding the shoe upper 102 to the bottom unit 106 is much faster than using conventional adhesives and/or solvents. The cooling time is very quick, thus the welded shoe assembly 100 does not need to remain in a jig (not shown) for long periods of time waiting for an otherwise glued joint to dry or cure. As a result, fewer lasts and jigs may suffice to manufacture a similar quantity of shoes as compared to traditional adhesive methods. Further, welding the shoe upper 102 to the bottom unit 106 can create a ‘cleaner’ joint than adhesive methods that may leave adhesive residue at undesired points on the surface of the shoe upper 102 and/or the bottom unit 106. These cleaner joints may eliminate a need for an overlay of the type commonly employed when adhesive methods are used.

In addition to the benefits described above, welding often creates a stronger joint than a glued joint. Thus, the welded shoe assembly 100 may be constructed with equal or greater durability as compared to a shoe assembly that is glued together, even if the welded surface area between the shoe upper 102 and the bottom unit 106 is equal or less than the surface area that would be otherwise glued together.

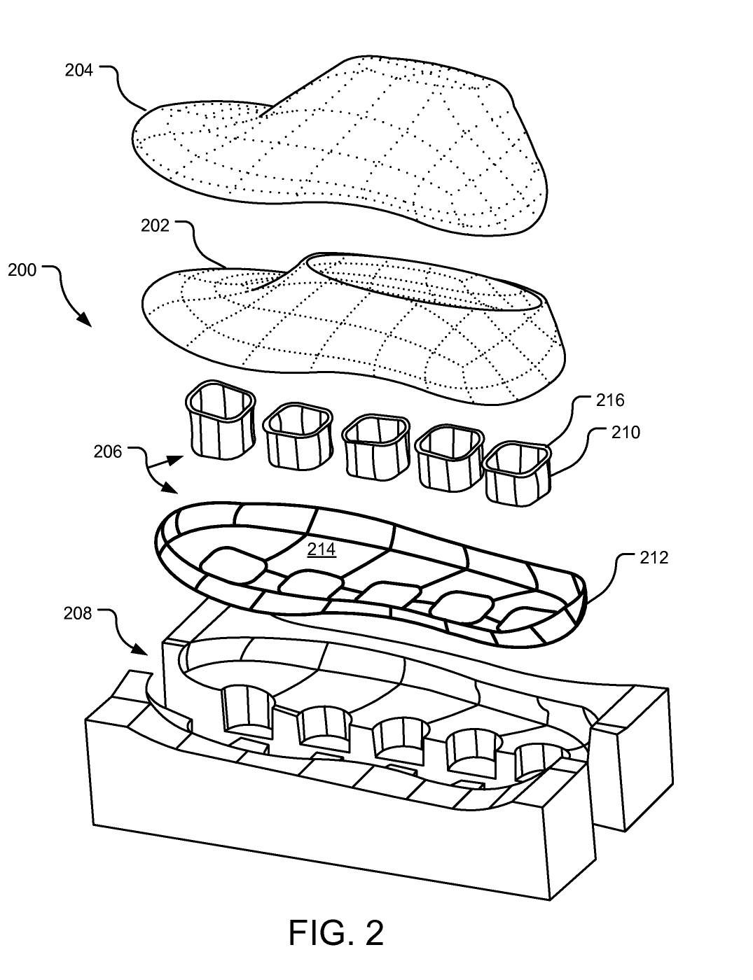

FIG. 2 is an exploded perspective view of an example shoe assembly 200 including a shoe upper 202 and a bottom unit 206 that may be welded together using a last 204 and a welding mold 208. The bottom unit 206 includes a carrier 212 and a number of cushioning elements (e.g., void cell 210) mountable to the carrier 212. The individual cushioning elements may be of any shape and size and include any material suitable to provide a desired elastic rebound and/or shock absorbing property to the shoe assembly 200. Further, the individual cushioning elements may vary in size, shape, and/or construction according to the location within the carrier 212. Here, a total of five cushioning elements are depicted, each cushioning element being an elastically compressible void cell.

The carrier 212 provides a mounting surface for arranging and attaching the individual cushioning elements to the shoe assembly 200. The carrier 212 allows the cushioning elements to be placed in specifically selected locations and further provides a medium for attaching the cushioning elements to the shoe upper 202. The number and placement of the cushioning elements in FIG. 2 are merely exemplary. In other implementations, the shoe assembly 200 includes more than five cushioning elements. For example, smaller cushioning elements may be distributed all about the interior surface 214 of the carrier 212.

According to one implementation, each of the cushioning elements is formed to have a flanged portion 216 with an outermost diameter that is greater than a diameter of a corresponding aperture (e.g., a through-hole) in the carrier 212. Consequently, each one of the cushioning elements can rest within a corresponding aperture in the carrier 212 with the associated flanged portion 216 contacting the interior surface 214 of the carrier 212. In other implementations, the bottom unit 206 includes cushioning elements formed integrally within it.

In some traditional shoe assembly processes, a foam midsole is included between the shoe upper 202 and a bottom unit (e.g., a non-foam midsole) to provide a surface for applying an adhesive and attaching the shoe upper 202 to the bottom unit 206. The presently-disclosed technology eliminates a need to include the foam midsole by facilitating direct attachment of the bottom unit 206 to the shoe upper 202.

During construction of the shoe assembly 200, the welding mold 208 is used in conjunction with the last 204 to compress the shoe upper 202 against the bottom unit 206. The interior surface 214 of the carrier 212 serves as an interface surface with the shoe upper 202, where the carrier 212 is welded to the shoe upper 202. The welding mold 208 is depicted as a split two-part mold, but in other implementations the welding mold 208 may be a single part mold or have more than two parts. In still other implementations, the welding mold 208 may not have a solid bottom surface, but rather apertures or supportive contours where the individual cushioning elements and/or the carrier 212 may reside during assembly.

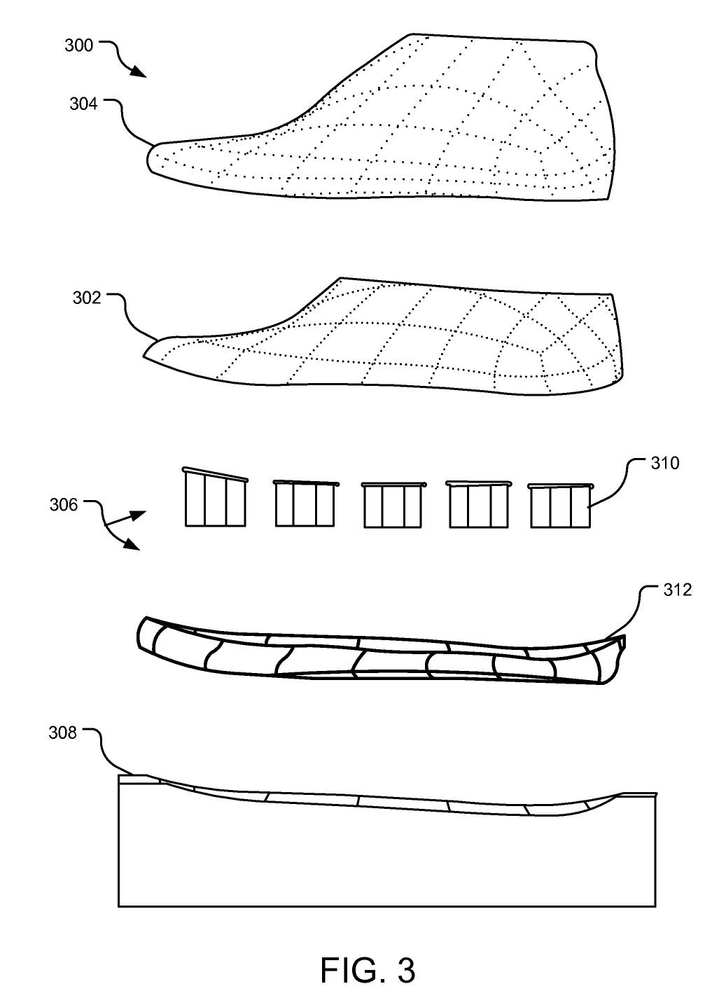

To weld together the shoe upper 202 and the bottom unit 206, an electromagnetic current can be generated to flow between the last 204 and the welding mold 208, thereby forming a bond at a contact interface between the bottom unit 206 and the shoe upper 202 (as explained in greater detail with respect to FIG. 3-8.

The use of additional pins (not shown) or other components as electrodes may enable the shoe assembly 200 to be welded together even when the physical arrangement of the shoe upper 202 and the bottom unit 206 prevents the last 204 from pushing one or more interface surface(s) of the shoe assembly 200 directly against the split mold. For example, pins may be inserted from the sides of the shoe assembly 200 to direct current to one or more interface surfaces that is imperfectly contacted by the welding mold 208. In yet other implementations, the electrodes are mounted within the shoe assembly 200 and are either withdrawn after welding or remain in place for the life of the shoe assembly 200. In still other implementations, the bottom unit 206 may include one or more elongated flanges (e.g., tabs, not shown) that wrap around the side of the shoe upper 202 that provide increased interface surface area between the shoe upper 202 and the bottom unit 206, improving the weld strength.

FIG. 3 is an exploded side view of an example shoe assembly 300 including a shoe upper 302 and a bottom unit 306 that may be welded together using a last 304 and a welding mold 308. In FIG. 3, the bottom unit 306 includes five cushioning elements (e.g., a cushioning element 310 including one or more void cells) mountable to a carrier 312. The carrier 312 provides a mounting surface for arranging and attaching the individual cushioning elements to the shoe assembly 300. The carrier 312 allows the cushioning elements to be placed in specifically selected locations and further provides a medium with which to attach a resulting array of cushioning elements to the shoe upper 302.

The welding mold 308 is used in conjunction with the last 304 to compress the shoe upper 302 against the bottom unit 306 and facilitate welding between respective adjacent surfaces. An interior surface (not shown) of the carrier 312 serves as an interface surface with the shoe upper 302, where the carrier 312 is welded to the shoe upper 302.

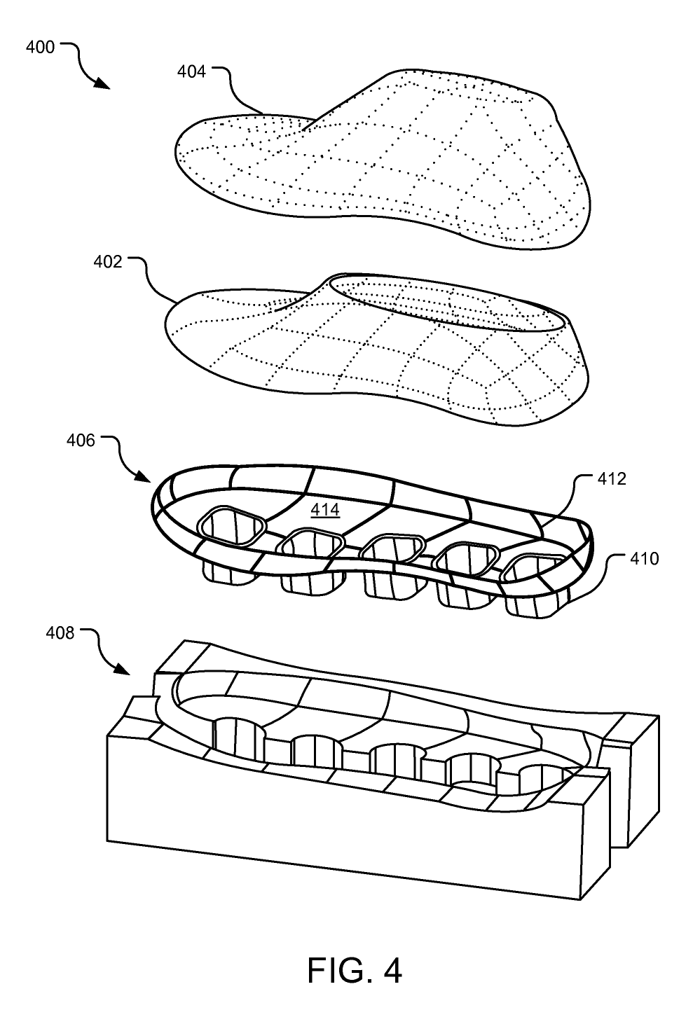

FIG. 4 is a perspective view of an example shoe assembly 400 during a first assembling operation. The shoe assembly 400 includes a shoe upper 402 that may be welded to a bottom unit 406 using a last 404 and a welding mold 408. In FIG. 4, cushioning elements (e.g., a cushioning element 410 including one or more void cells) of the bottom unit 406 are inserted into corresponding apertures (e.g., through-holes) in a carrier 412. Although the cushioning elements and the carrier 412 may be formed as a singular (e.g., monolithic) component, attaching the cushioning elements to the carrier 412 as illustrated permits for closer spacing of the cushioning elements (i.e., more cushioning elements per unit area) and may improve midsole response characteristics.

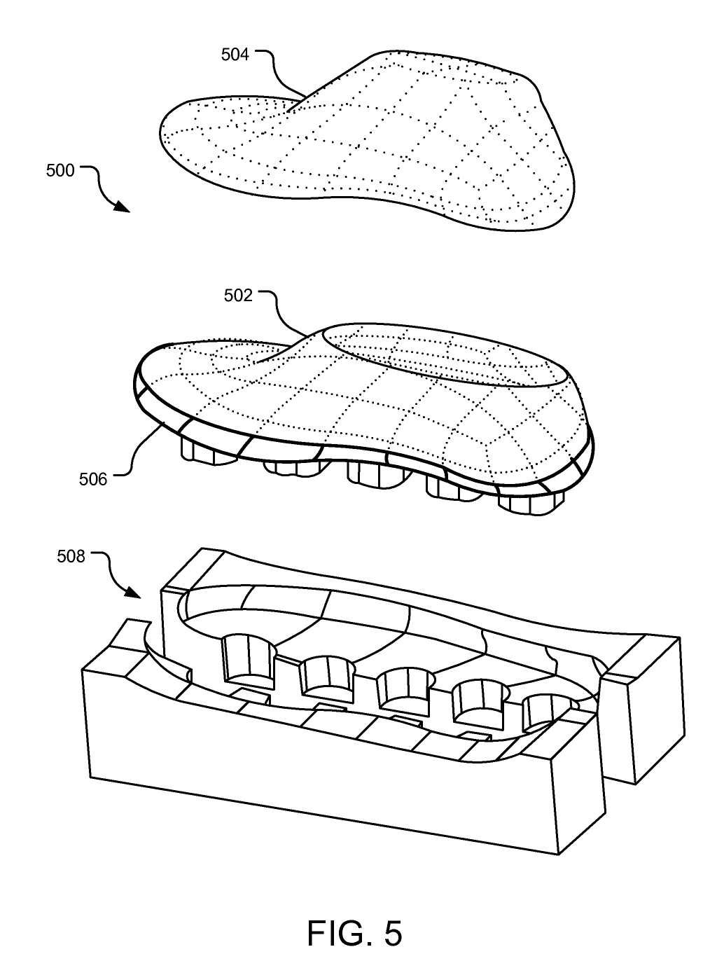

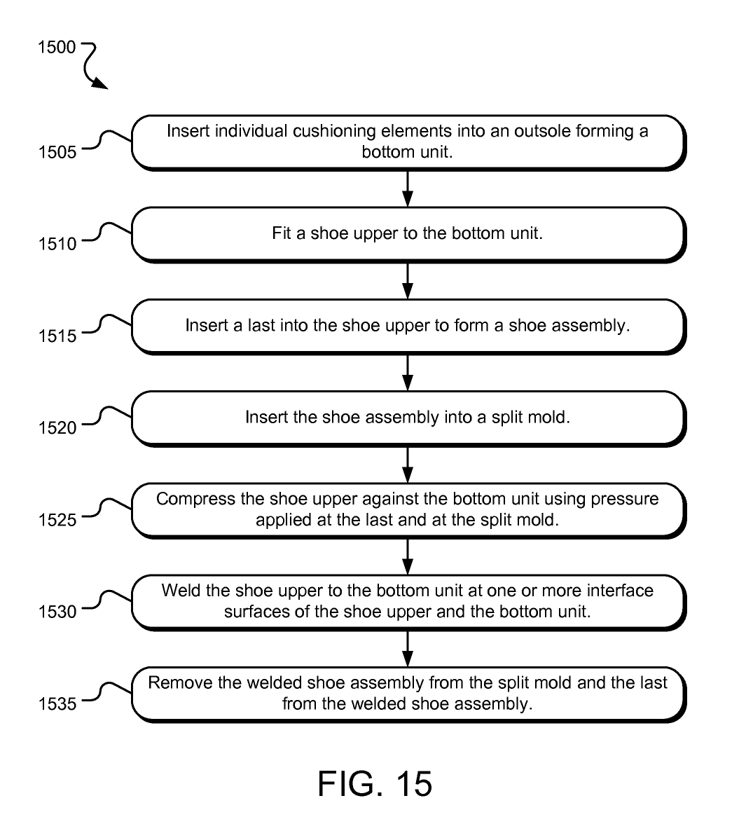

FIG. 5 is a perspective view of an example shoe assembly 500 during a second assembling operation (see e.g., fitting operation 1510 of FIG. 15). The shoe assembly 500 includes a shoe upper 502 that may be welded to a bottom unit 506 using a last 504 and a welding mold 508. In FIG. 5, the bottom unit 506 is fitted (e.g., positioned directly adjacent to) the shoe upper 502 so the bottom unit 506 receives and cradles the shoe upper 502.

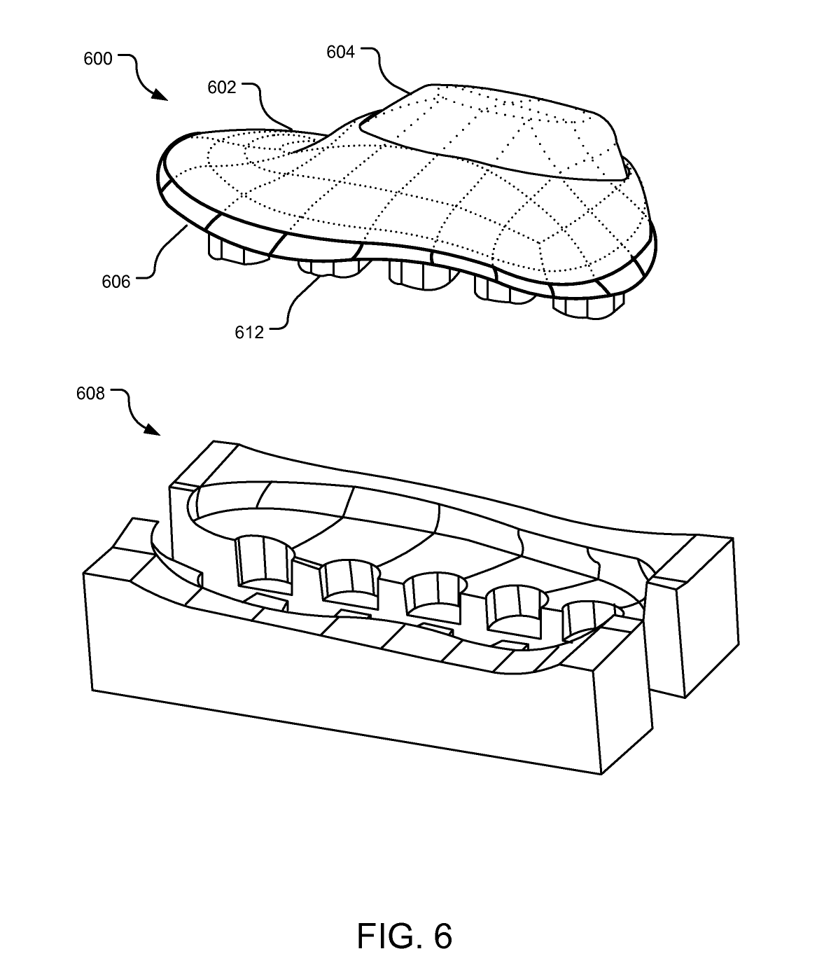

FIG. 6 is a perspective view of an example shoe assembly 600 during a third assembling operation. The shoe assembly 600 includes a shoe upper 602 that may be welded to a bottom unit 606 using a last 604 and a welding mold 608. In FIG. 6, the last 604 simulates a user's foot and is inserted within the shoe upper 602.

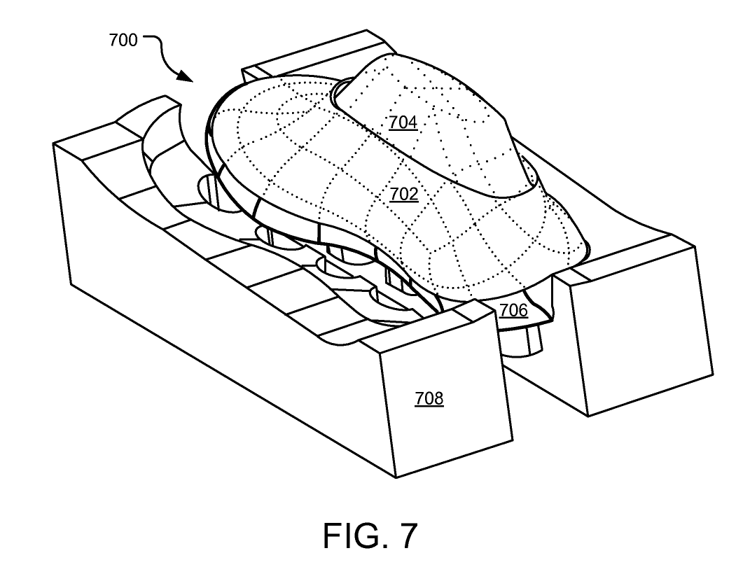

FIG. 7 is a perspective view of an example shoe assembly 700 during a fourth assembling operation. The shoe assembly 700 includes a shoe upper 702 that may be welded to a bottom unit 706 using a last 704 and a welding mold 708. In FIG. 7, an assembly of components (e.g., the bottom unit 706, the shoe upper 702, and the last 704) are fitted within the welding mold 708. In a subsequent operation (described below), the welding mold 708 is used in conjunction with the last 704 to compress the shoe upper 702 against the bottom unit 706 for a welding operation. An interior surface (not shown) of the bottom unit 706 serves as an interface surface with the shoe upper 702, where the bottom unit 706 is welded to the shoe upper 702.

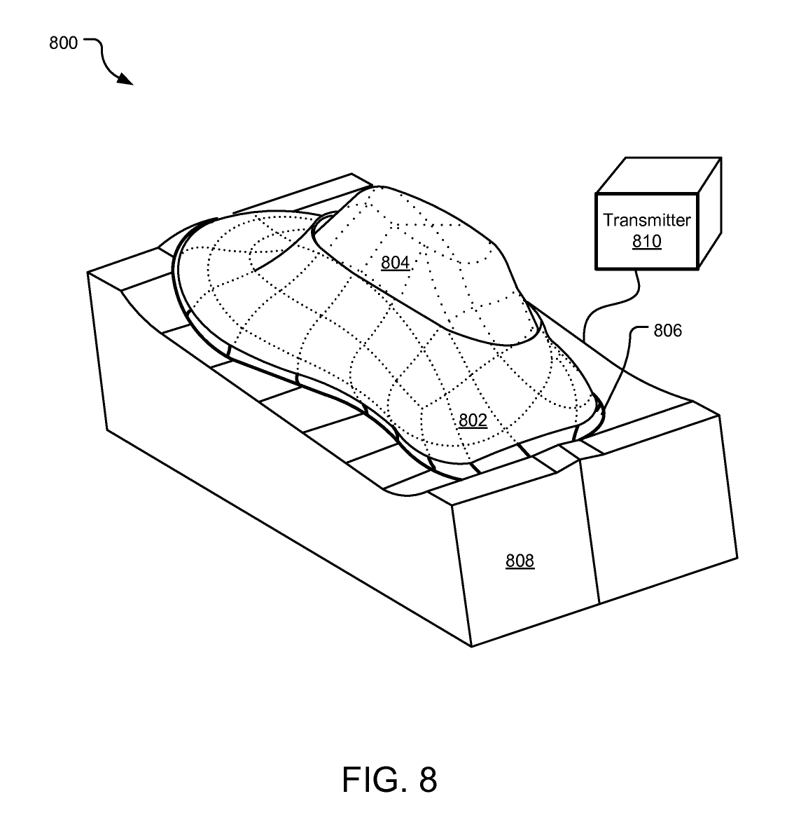

FIG. 8 is a perspective view of an example shoe assembly 800 during a fifth assembling operation. The shoe assembly 800 includes a shoe upper 802 that may be welded to a bottom unit 806 using a last 804 and a welding mold 808. The shoe upper 802 and bottom unit are shown compressed between the last 804 and the welding mold 808. An interior surface of the bottom unit serves as an interface surface with the shoe upper 802, where the bottom unit 806 is welded to the shoe upper 802.

A transmitter 810 is electrically coupled to the welding mold 808 and applies a high frequency electrical field to the welding mold 808. In one implementation, the transmitter 810 is an RF transmitter. In another implementation, the transmitter 810 generates ultrasonic acoustic vibrations. In various implementations, the transmitter 810 may apply the signal to one or more locations on the welding mold 808 and/or the last 804. The high-frequency electrical field causes molecules in the shoe upper 802 and the bottom unit 806 to move and generate heat. This combination of heat under pressure applied by the mold creates a welding joint at the areas under pressure.

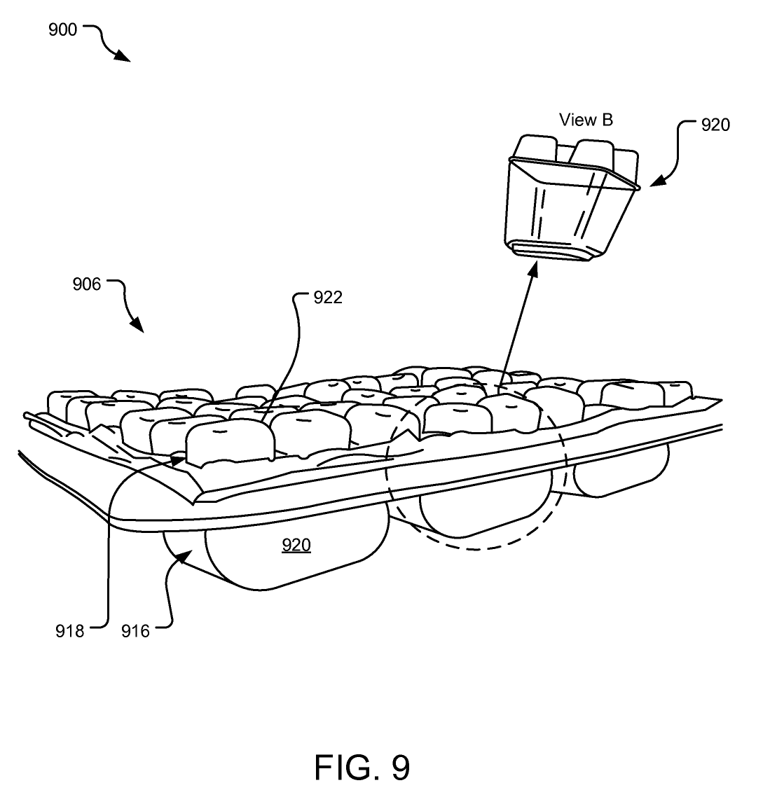

In one implementation, the bottom unit 806 may be formed from a carrier and one or more cushioning elements (e.g., the cushioning element 210 of FIG. 2, above). A few example cushioning elements are described in greater detail below with respect to FIGS. 9-14. In various implementations, the individual cushioning elements of each shoe assembly bottom unit 806 include at least one void cell, and may include multiple void cells. For example, a single cushioning element may include multiple interfacing void cells. The cushioning elements are created by thermoforming two or more sheets of plastic material and then cutting the thermoformed plastic sheets into multiple components.

FIG. 9 is a perspective view of an example molded structure 900 including a number of cushioning elements suitable for integration into a bottom unit of a shoe assembly, such as according to the welding techniques discussed above. The molded structure 900 includes two molded void cell layers 916, 918, each of which includes an array of void cells (e.g., void cells 920, 922). In operation, the molded structure 900 may be cut or otherwise divided into multiple separate cushioning elements individually insertable into a carrier of shoe assembly, such as the carrier 212 of FIG. 2.

In FIG. 9, the individual void cells included in the molded cell layer 916 (e.g., cell 920) are larger than the individual void cells included in the molded cell layer 918 (e.g., cell 922). Further, the individual void cells included in the molded cell layer 916 have open faces oriented toward open faces of the individual void cells included in the molded cell layer 918. In various implementations, the individual void cells are open or closed and rely on wall stiffness and/or air compression to provide the desired elastic rebound and/or shock absorbing properties.

View B of FIG. 9 illustrates an individual cushioning element 920 that is formed integrally as part of the molded structure 900 and subsequently separated from the molded structure 900. The cushioning element 920 includes five void cells. A first large void cell has an open surface that faces open surfaces of four smaller void cells. In other implementations, the cushioning element 920 may make use of different numbers, sizes of void cells, and/or arrangements of void cells. In general, the cushioning elements formed from the molded void cell layers 916, 918 provide a desired elastic rebound and/or shock absorbing property when integrated into a welded shoe assembly.

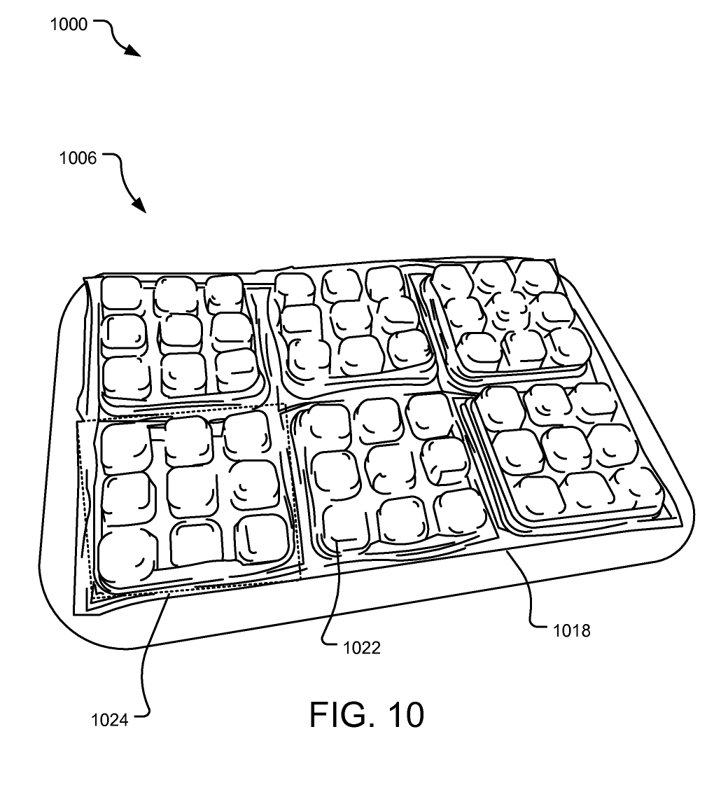

FIG. 10 is a top view of another example molded structure 1000 including a number of cushioning elements suitable for integration into a bottom unit of a shoe assembly. The molded structure 1006 includes two molded void cell layers, one of which is visible in FIG. 10 (i.e., void cell layer 1018). The void cell layer 1018 includes an array of void cells (e.g., void cell 1022). In operation, the molded structure 1000 may be subsequently cut or otherwise divided into multiple separate cushioning elements, such as the cushioning element 920 of FIG. 9. For example, one cushioning element may be formed by cutting through the molded structure 1000 along a path indicated by a dotted line 1024.

Each of the molded void cell layers of the molded structure 1000 may include void cells that are sized, shaped, and/or arranged differently from one another. For example, a bottom void cell layer (not shown) includes a number of larger void cells corresponding to (e.g., aligned with) a number of smaller void cells (e.g., a void cell 1022) of the void cell layer 1018.

FIG. 11 is a bottom view of another example molded structure 1100 including a number of cushioning elements suitable for integration into a bottom unit of a shoe assembly. The molded structure 1100 includes two molded void cell layers, one of which is visible in FIG. 11 (i.e., void cell layer 1116). The void cell layer 1116 includes an array of void cells (e.g., void cell 1120). In operation, the molded structure 1100 may be subsequently cut or otherwise divided into multiple separate cushioning elements, such as cushioning element 920 of FIG. 9. For example, one cushioning element may be formed by cutting through the molded structure 1100 along a path indicated by a dotted line 1126.

The molded void cell layers provide a desired elastic rebound and/or shock absorbing property. Each of the molded void cell layers of the molded structure 1100 may include void cells that are sized, shaped, and/or arranged differently from one another. For example, a bottom void cell layer (not shown) includes a number of smaller void cells corresponding to (e.g., aligned with) each individual larger void cell (e.g., a void cell 1120) of the void cell layer 1116. In one implementation, groupings of nine void cells in the bottom void cell layer (not shown) correspond to a single void cell in the void cell layer 1116, such as the void cell 1120. In some implementations, void cells within the same void cell layer are of different sizes and/or shapes.

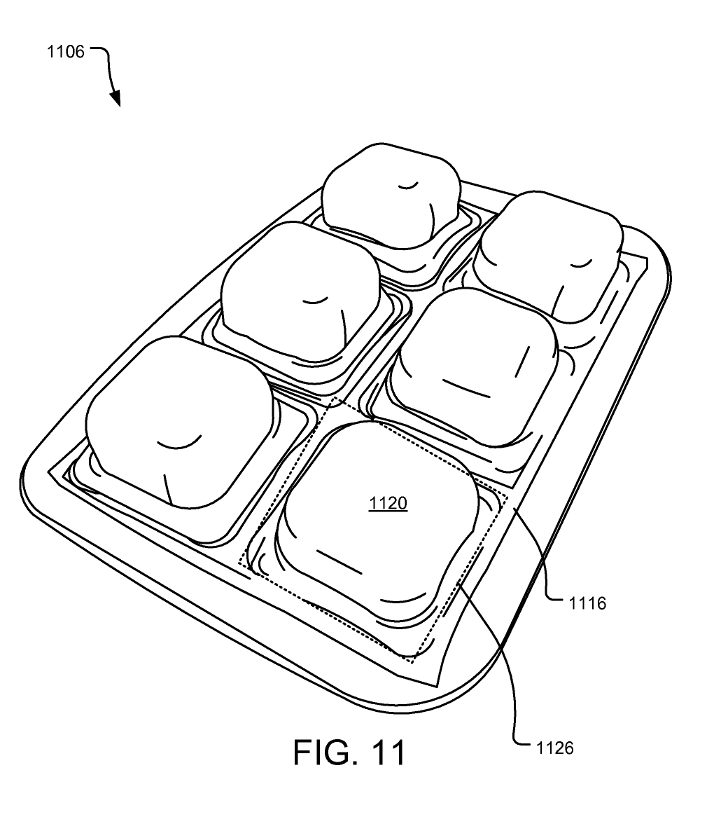

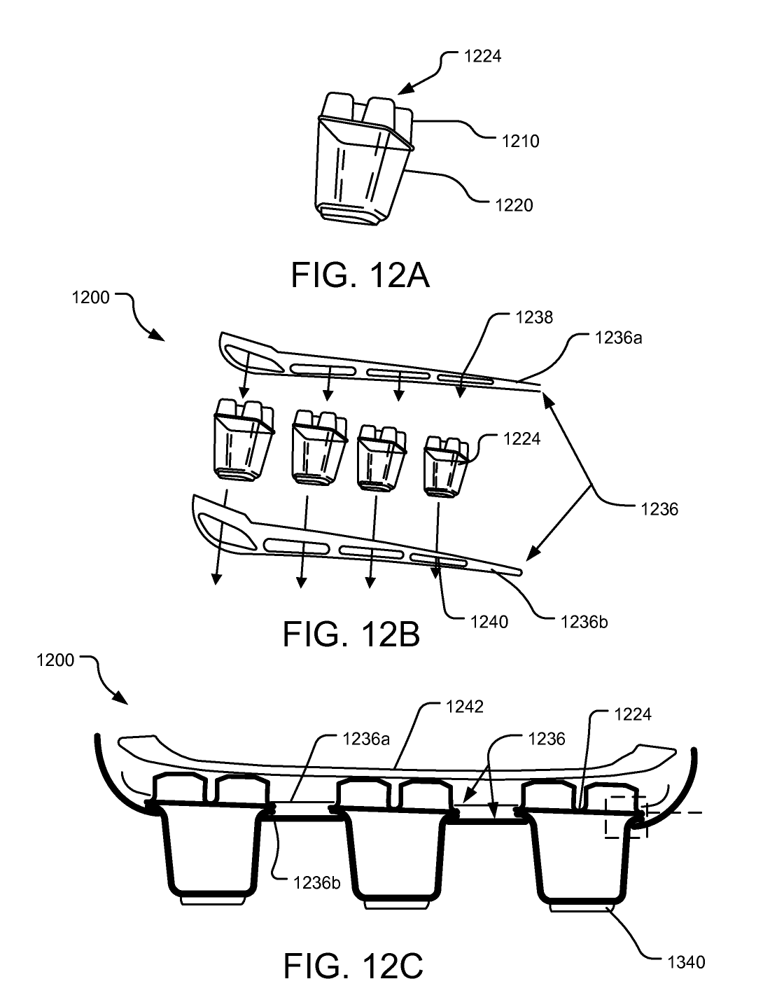

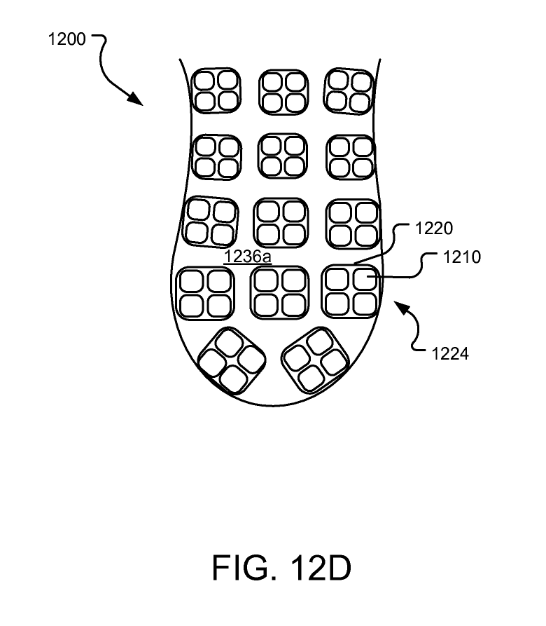

FIG. 12A-12C illustrate different stages of construction of an example welded bottom unit 1200 suitable for use in a shoe assembly. FIG. 12A illustrates a first stage of construction of the bottom unit 1200 during which individual void cell units (also referred to as “cushioning elements”) of a bottom unit are formed from one or more individual void cells. In one example implementation, two plastic sheets are thermoformed to create an array of void cell units. The thermoformed sheets are cut in various places to separate the void cell units from one another. In FIG. 12A, the void cell unit 1224 includes four smaller void cells (e.g., a smaller void cell 1210) bonded to a larger void cell 1220 such that open faces of the smaller void cells are oriented toward and aligned with an open face of a larger void cell 1220.

In one implementation, the void cell unit 1224 is subsequently integrated within a shoe assembly such that the smaller void cells 1210 are oriented to interface with a user's foot (not shown), thereby distributing a load across a greater number of points (potentially increasing comfort) than the larger void cells 1220, which are oriented downward and interface with a ground surface. Further, the upwardly oriented void cells (not shown) may have a lower resistance to compression, increasing comfort to the user, as compared to the downwardly oriented void cells (not shown), which may have a higher resistance to compression, increasing support and/or impact protection to the user. In another example implementation, the void cell unit 1224 constructed of a column of individual stacked void cells. In various implementations, the void cell unit 1224 is able to substantially deflect in a lateral direction greater than 20% of the void cell unit's overall height.

The individual void cells in each void cell unit may have different compression and rebound characteristics tuned to provide a desired level of performance to the user. Further, the individual void cells in each void cell unit may include geometric features that increase (e.g., ribs) or decrease (e.g., indentations) the void cell's compression and rebound characteristics.

FIG. 12B illustrates the bottom unit 1200 during a second stage of construction. In FIG. 12B, a dual-layer carrier 1236 of the bottom unit 1200 receives a number of void cell units (e.g., the void cell unit 1224). The dual-layer carrier 1236 includes an upper layer 1236a and a lower layer 1236b that each includes a number of through-holes for receiving the various void cell units, as shown.

Each of the void cell units is oriented between and inserted into corresponding cavities formed in the upper layer 1236a and the lower layer 1236b of the dual-layer carrier 1236. For example, the void cell unit 1224 is inserted through corresponding apertures 1238 and 1240. In one implementation, the upper layer 1236a and the lower layer 1236b of the dual-layer carrier 1236 are welded or otherwise attached together (e.g., at attachment points between the interspersed void cell units). In another implementation, the individual void cell units are also welded to the upper layer 1236a and the lower layer 1236b. In yet another implementation, the void cell units are not welded to one another but are instead merely trapped between the upper layer 1236a and the lower layer 1236b of the dual-layer carrier 1236.

FIG. 12C illustrates a cross-sectional elevation view of the bottom unit 1200 after a third stage of construction. Specifically, FIG. 12C illustrates various void cell units (e.g., the void cell unit 1224) oriented between and inserted into corresponding cavities in the dual layer carrier including the upper layer 1236a and the lower layer 1236b. In one implementation, the upper layer 1236a and the lower layer 1236b of the carrier are welded together in areas between the cushioning elements, such as by using a specially-designed mold and welding techniques similar to those discussed with respect to FIGS. 1-8, above.

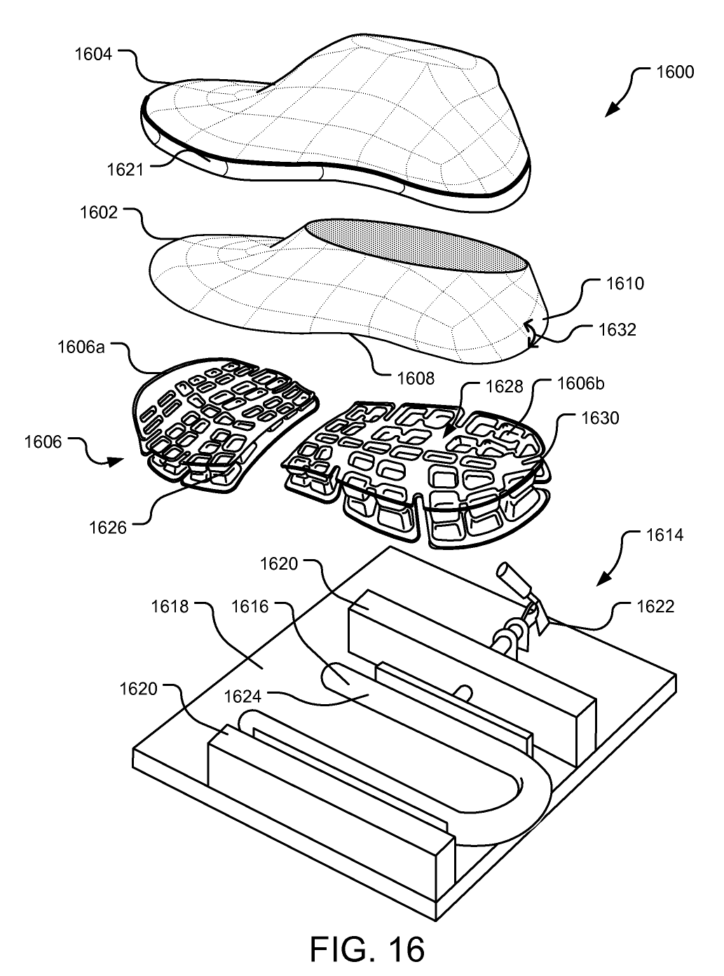

Further, a shoe upper 1242 is shown oriented above the dual-layer carrier 1236 and above all of the void cell units. In various implementations, the shoe upper 1242 is attached or merely compression-fitted to the bottom unit 1200 (i.e., the dual-layer carrier 1236 and the void cell units positioned therein) and provides primarily a comfort function, spreading out the load applied by the individual void cell units to the user's foot. In one implementation, a perimeter weld seals the shoe upper 1242 to the upper layer 1236a of the carrier. The perimeter weld may be performed, for example, according to techniques discussed below with respect to FIGS. 16-18.

An outsole 1244 is shown attached to the bottom surface of the individual void cell units. In the depicted implementation, the outsole 1244 is discontinuous and merely covers the bottom surfaces of the individual void cell units. This reduces the total quantity of outsole material needed for the bottom unit 1200. In other implementations, the outsole 1240 is continuous and covers the entire bottom surface of the bottom unit 1200. In some implementations, the outsole 1240 is made of urethane cast directly to the individual void cell units. In other implementations, the outsole 1240 is made of thermoplastic urethane and is welded to the individual void cell units.

FIG. 12D illustrates an inside top view of the example bottom unit 1200 of FIG. 12C. The inside top view 1200 illustrates an array of individual void cell units (e.g., void cell unit 1224) constructed of an array of four smaller void cells (e.g., smaller void cell 1210) inwardly-facing and bonded to a larger void cell 1220. The individual void cell units are oriented inserted into corresponding cavities in a dual-layer carrier 1236.

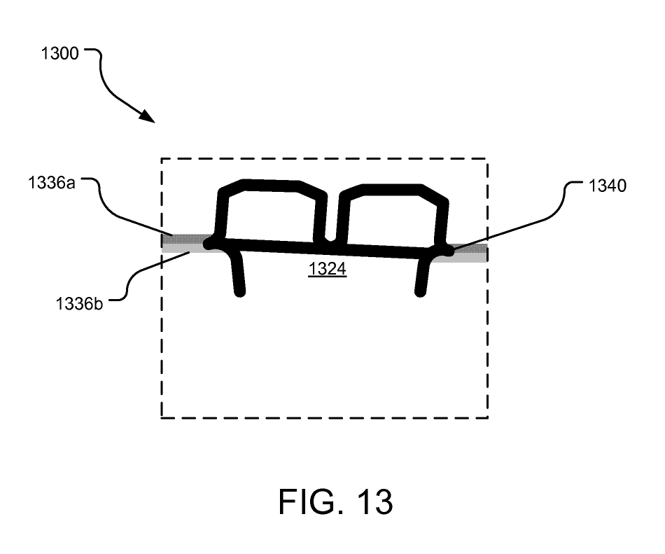

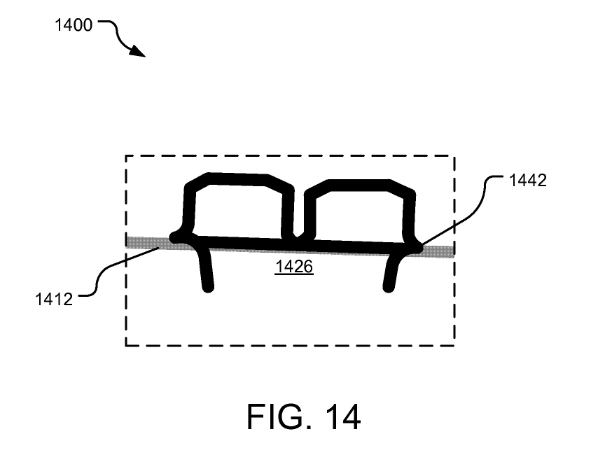

FIGS. 13 and 14 illustrate detail elevation views 1300, 1400 of two example bottom unit construction techniques. In FIG. 13, a void cell unit 1324 is depicted protruding through a through-hole in an upper layer 1336a and a lower layer 1336b of a dual-layer carrier. For example, the void cell unit 1324 includes a flange 1340 that rests between the upper layer 1336a and the lower layer 1336b of the dual component carrier. The void cell unit 1324, the upper layer 1336a and the lower layer 1336b may be welded, glued, and/or mechanically bonded together.

In FIG. 14, a void cell unit 1426 is depicted as projecting through a corresponding cavity in a single layer carrier 1412. The void cell unit 1426 includes a flange potion 1442 that is attached to a top surface of the single layer carrier 1412. The void cell unit 1426 and the carrier 1412 can then be welded, glued, and/or mechanically bonded together. In another implementation, the flange 1442 of the void cell unit 1426 is oriented at the bottom surface of the single layer carrier 1412. This alternative construction may allow the void cell units 1426 to be positioned within the welding tool prior to welding to the carrier 1412.

FIG. 15 illustrates example operations 1500 for assembling a welded shoe assembly. A first inserting operation 1505 inserts individual cushioning elements (e.g., individual void cells or void cell units) into a carrier forming a bottom unit. The individual cushioning elements may be of any size or shape and the selected size and/or shape may vary based on intended placement on the carrier. In one implementation, the carrier includes openings specifically sized to accept the individual cushioning elements. In some implementations, the carrier includes two carrier layers and the individual cushioning elements are inserted between the carrier layers.

A fitting operation 1510 fits a shoe upper to the bottom unit. The shoe upper provides an enclosure or other mechanism to fasten the shoe assembly to a user's foot. The bottom unit engages the shoe assembly with the ground and provides improved durability, traction, and/or cushioning to the user's foot when used in conjunction with the shoe upper. The shoe upper is formed to fit to the bottom unit at one or more interface surfaces.

A second inserting operation 1515 inserts a last into the shoe upper to form a shoe assembly. The last is a mechanical form that has a shape similar to that of the user's foot and approximates the user's foot during operations 1520-1530. A third inserting operation 1520 inserts the shoe assembly into a split mold. The split mold is a mechanical form that has a shape that corresponds to the shape of the bottom unit of the shoe assembly. In some implementations, the mold is split to assist removal of the shoe assembly from the mold. In other implementations, the mold is not split.

A compressing operation 1525 compresses the shoe upper against the bottom unit using pressure applied at the last and the split mold. In other words, the shoe assembly is compressed between the last and the split mold. The compression operation 1525 causes one or more interface surfaces between the bottom unit and the shoe upper to be in direct contact with one another. In various implementations, the interface surfaces may include a line about a perimeter of the shoe assembly, regularly spaced points between the shoe upper and the bottom unit, or other patterns that provide adequate surface area to weld the shoe upper to the bottom unit. In implementations where the interface surface(s) is visible from the exterior when the shoe assembly is welded together, the interface surface(s) may be incorporated as a design element of the shoe assembly.

A welding operation 1530 welds the shoe upper to the bottom unit at one or more interface surfaces of the shoe upper and the bottom unit. The welding operation occurs at one or more interface surfaces where the bottom unit and the shoe upper are in direct contact with one another. A variety of welding techniques may be used to accomplish the welding operation 1530 (e.g., rf welding and ultrasonic welding). A removing operation 1535 removes the welded shoe assembly from the split mold and the last from the welded shoe assembly. In some implementations, the mold is split to aid the removing operation 1535.

The welding techniques described above (e.g., with respect to FIGS. 1-15) generally rely on contact between opposing surfaces of weldable materials. However, some designs include surface contours, gaps, voids, etc. that can increase the difficultly of achieving adequate surface contact. When surface contact is imperfect, the resulting structure may suffer from weak bonds and/or undesireable gaps at one or more welding interfaces. Therefore, the welding techniques discussed above may not be suitable for some shoe assembly designs.

FIGS. 16-18 illustrate aspects of an alternative welding technique that allows for welding between contoured (e.g., three dimensional) surfaces in a shoe assembly. The technique is primarily discussed with reference to shoe welding, but may be naturally extendable to structures other than shoes where welding is desired at a non-planar contact interfaces.

FIG. 16 is an exploded perspective view of an example shoe assembly 1600 including a shoe upper 1602 and a bottom unit 1606 that may be welded together using a last 1604 and a welding mold assembly 1614. In one implementation, the bottom unit 1606 and the shoe upper 1602 are both formed of or coated with a plastic material. The last 1604 is insertable within the shoe upper 1602 to approximate a user's foot. An outer surface of the last 1604 is conductive so that the last may serve as an electrode during a welding operation that bonds the shoe upper 1602 to the bottom unit 1606.

The bottom unit 1606 is a dual-component layer including a forefoot component 1606a and a heel component 1606b. In other implementations, the bottom unit 1606 may include fewer or greater numbers of components. The example bottom unit 1606 includes multiple layers of thermoformed plastic material, which make it challenging to achieve adequate surface contact with a shoe upper during a welding operation. For example, a traditional planar (e.g., plate-like) electrode may not easily be placed into contact with a top sheet of material of the bottom unit (e.g., the sheet forming an upper surface 1628). However, the welding mold assembly 1614 addresses this challenge by facilitating welding along a contoured outer perimeter surface of the bottom unit 1606 and the shoe upper 1602.

In particular, the bottom unit 1606 includes a curved flange perimeter portion 1630 that is to be welded to a matching contour of the outer perimeter surface 1610 of the shoe upper 1602. The above-described welding is facilitated, in part, by three-dimensional electrodes formed to mate with the shoe upper 1602 and the bottom unit 1606. The last 1604 acts as a first electrode and a conductive mold component 1616 of the welding mold assembly 1614 acts as an opposing electrode. The conductive mold component 1616 and the last 1604 straddle and apply a compression force to a contact interface between opposing non-planar surfaces of the shoe upper 1602 and the bottom unit 1606 within the vicinity of a desired welding area (e.g., the outer perimeter surface 1610). While the shoe upper 1602 and the bottom unit 1606 are subjected to a compressive force, high-frequency (e.g., about 27 MHz) electromagnetic waves are passed through the shoe upper 1602 and the bottom unit 1606 along a path between the last 1604 and the conductive mold component 1616.

The upper surface 1628 of the bottom unit 1606 includes a material readily weldable to a lower surface 1608 of the shoe upper 1602, such as one or more of the weldable materials described above with respect to FIG. 1 (e.g., a dipolar material). As noted by arrow 1632, an outer perimeter surface 1610 of the shoe upper 102 may be non-planar (e.g., curved, angled, notched, grooved, etc.). Likewise, a corresponding surface of the bottom unit 1606 may be non-planar, such as to flare up and around a portion of the outer perimeter surface 1610 of the shoe upper 1602.

The welding mold assembly 1614 may include a variety of different features that serve different functions in different implementations. In FIG. 16, the welding mold assembly 1614 includes the conductive mold component 1616, a base portion 1618, adjustable compression flanges 1620, and an adjustment mechanism 1622. Other implementations may not include one or more of such features and/or may include other features in lieu of or in addition to one or more of such features.

The conductive mold component 1616 may vary in size and shape from one implementation to another, but is, in FIG. 16, a u-shaped component including a non-planar inner perimeter surface 1624 designed to mate with (e.g., rest snugly against) a non-planar outer perimeter surface 1621 of the last 1604. In the illustrated implementation, the non-planar inner perimeter surface 1624 of the conductive molded component 1616 has a convex (e.g., tubular) shape designed to nest within a concave perimeter feature (e.g., an elongated groove) of the outer perimeter surface 1621 of the last 1604. The concave/convex features are engineered to match or otherwise create a surface contour between weldable surfaces of the shoe upper 1602 and the bottom unit 1606.

During welding, the non-planar outer perimeter surface 1621 and the non-planer inner perimeter surface 1624 (collectively, the perimeter surfaces 1621 and 1624) nest adjacent to one another on opposite sides of the shoe upper 1602 and bottom unit 1606 so as to compress the curved flange perimeter portion 1630 of the bottom unit 1606 against a matching contour of the outer perimeter surface 1610 of the shoe upper 1602. These weldable surfaces of the shoe upper 1602 and bottom unit 1606 (e.g., the outer perimeter surface 1610 and a surface including the curved flanged perimeter portion 1630) may be rigid enough to independently assume non-planar surface contours (as shown) and/or engineered to assume specific non-planar shapes while under the compressive force applied by the perimeter surfaces 1621 and 1624. In various implementations, the perimeter surfaces 1621 and 1624 assume a variety of other shapes and contours selected to ensure maximum contact between the weldable surface of the shoe upper 1602 and the corresponding weldable surface of the bottom unit 1606.

During a welding operation, adjustable compression flanges 1620 of the welding mold assembly 1614 apply an inward compressive force to opposite sides of the conductive mold component 1616. In various implementations, the conductive molded component 1616 may be a rigid or flexible component with a conductive exterior. For example, the conductive mold component 1616 may be a conductive tubing or a non-conductive tubing coated with a conductive material, such as a plating or conductive tape.

In one implementation, the conductive mold component 1616 is pliable under a compressive force to provide substantially uniform contact consistency with an adjacent surface during RF welding. For example, the conductive molded component 1616 may include foam, plastic, rubber, soft metals, etc. In some implementations, the conductive molded component 1616 is a hollow structure, such as a hollow tubing structure filled with a liquid or gas to provide outward pressure, such as an air-tight inflatable tubing, water-tight water bag, etc. In another implementation, the last 1604 is pliable under a compressive force to provide uniform contact consistency as described above. In some implementations, one (but not both) of the conductive mold components 1616 and the last 1604 is rigid rather than pliable. In still other implementations, both the conductive mold component 1616 and the last 1604 are pliable.

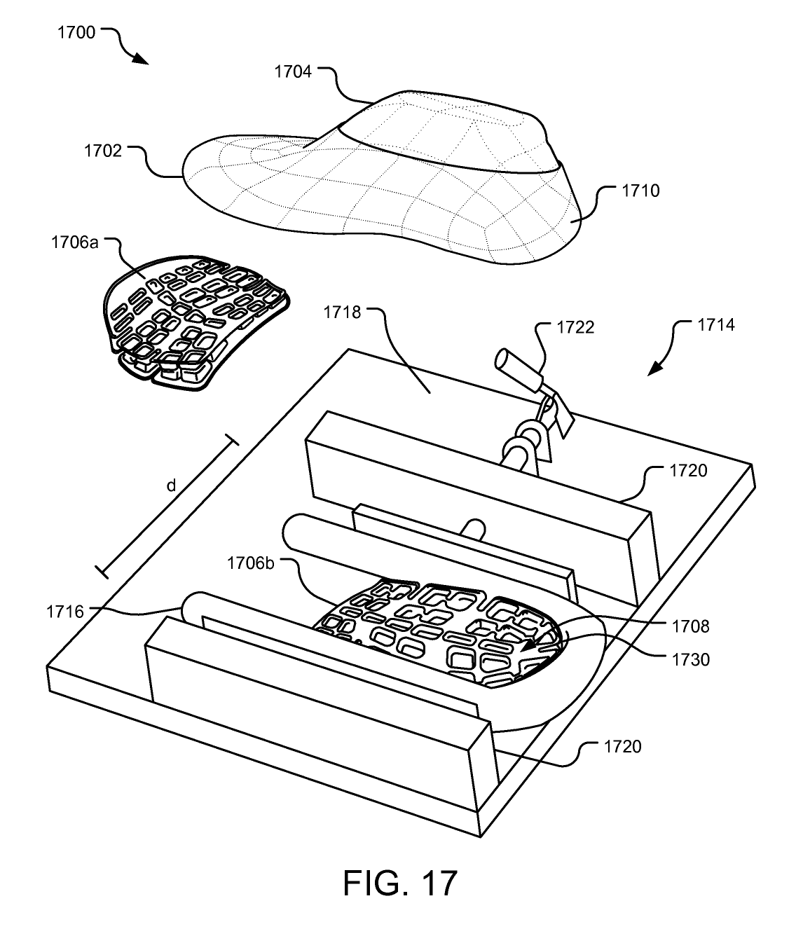

FIG. 17 is perspective view of an example shoe assembly 1700 during a first stage of a three-dimensional welding process. The shoe assembly 1700 includes a shoe upper 1702 that may be welded to a bottom unit 1706 using a last 1704 and a welding mold assembly 1714. In preparation for an RF welding operation, the last 1704 is inserted into the shoe upper 1702 and an adjustment mechanism 1722 of the welding mold assembly 1714 is loosened to increase a separation distance ‘d’ between adjustable compression flanges 1720. This relaxes an inward pressure on opposite sides of a conductive mold component 1716, allowing for a portion of the bottom unit 1706 (e.g., either a front portion 1706a or a back portion 1706b, depending on a desired welding operation) to be inserted into an area within the u-shape of the conductive mold component 1716, as shown. In FIG. 17, the back portion 1706b is shown positioned for a welding operation, oriented within and directly adjacent to the conductive mold component 1716.

The bottom unit 1706 includes a curved flange perimeter portion 1730 with a curvature designed to substantially match a curvature of an outer perimeter surface 1710 of the shoe upper 1702. This curved flange perimeter portion 1730 lies in contact with an inner and/or upper surface of the conductive mold component 1716 (e.g., the upper surface facing away from a base portion 1718 of the welding mold assembly 1714 and toward the shoe upper 1702).

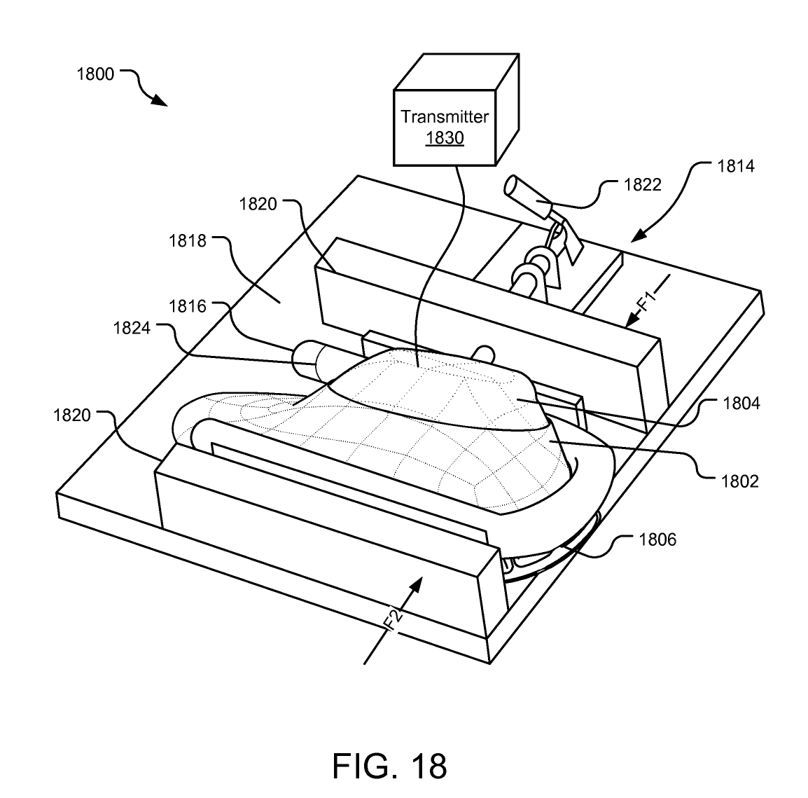

FIG. 18 is perspective view of another example shoe assembly 1800 during another phase of a three-dimensional welding process. The shoe assembly 1800 includes a shoe upper 1802 that may be welded to a portion of a bottom unit 1806 (partially shown) using a last 1804 and a welding mold assembly 1814. In FIG. 18, the shoe upper 1802 (with the last 1804 inserted therein) is placed on the bottom unit 1806 on the welding mold assembly 1814 such that a curved, outer perimeter surface of the shoe upper 1802 is adjacent to and in contact with a curved flange perimeter portion (not shown) of the bottom unit 1806. An adjustment mechanism 1822 is then tightened to supply a compressive force to opposite sides of the conductive mold component 1816 (e.g., a compressive force in the direction of arrows F1, F2). This compressive force presses the bottom unit 1806 against the shoe upper 1802 in a region directly between the last 1804 and conductive mold component 1816, creating (or re-enforcing an existing) non-planar contact interface.

In one implementation, the last 1804 and/or the conductive mold component 1816 are engineered to bend slightly under force of the adjustable compression flanges 1820 to supply a seal of substantially uniform pressure between the last 1804 and the conductive mold component 1816. For example, the conductive mold component 1816 may be an air-filled rubber tube with conductive coating. When under force of the adjustable compression flanges 1820, the rubber tube bends slightly to create an air-tight seal against the bottom unit 1806 and shoe upper 1802.

With the adjustable compression flanges 1820 tightened as described above, a transmitter 1830 is powered to apply a high frequency electrical field to the either the last 1804 or the conductive mold component 1816, causing current of an electromagnetic field to flow between the last 1804 and the conductive mold component 1816. The electromagnetic field creates a welded joint between the shoe upper 1802 and the bottom unit 1806 in a perimeter region abutting the conductive mold component 1816. In one implementation, the transmitter 1830 is an RF transmitter. In another implementation, the transmitter 1830 generates a low-amplitude, high-frequency acoustic vibrations.

The bottom unit 1806 may include a single component or multiple components (e.g., as in the bottom unit 1706 of FIG. 17). In one implementation, the bottom unit 1806 includes two components. In the illustrated welding operation, a heel portion of the bottom unit 1806 is welded to the shoe upper 1802. In another welding operation, a toe portion of the shoe upper 1802 is placed adjacent to the conductive mold component 1816, the shoe assembly is rotated 180 degrees (e.g., relative to the illustrated position), and re-secured within the welding mold assembly 1814 such that the a toe portion of the shoe upper 1802 is adjacent to the toe portion of the bottom unit 1806. The toe portion of the bottom unit 1806 is then welded to the shoe upper 1802 in a same or similar manner as that described above.

The welding system of FIG. 18 may be used alone or in conjunction with a welding machine including planar plate electrodes. In one implementation, the welding mold assembly 1814 is inserted into an RF welding press between a top plate electrode and a bottom plate electrode with the shoe assembly 1800 secured to the welding mold assembly 1814 as shown in FIG. 18. The top and bottom plate electrodes supply a current that flows between the last 1804 and the conductive mold component 1816. For example, the base portion 1818 of the welding mold assembly 1814 may be placed on a bottom plate electrode (not shown) and an opposing top plate electrode (not shown) may be brought into contact with an exposed upper portion of the last 1804.

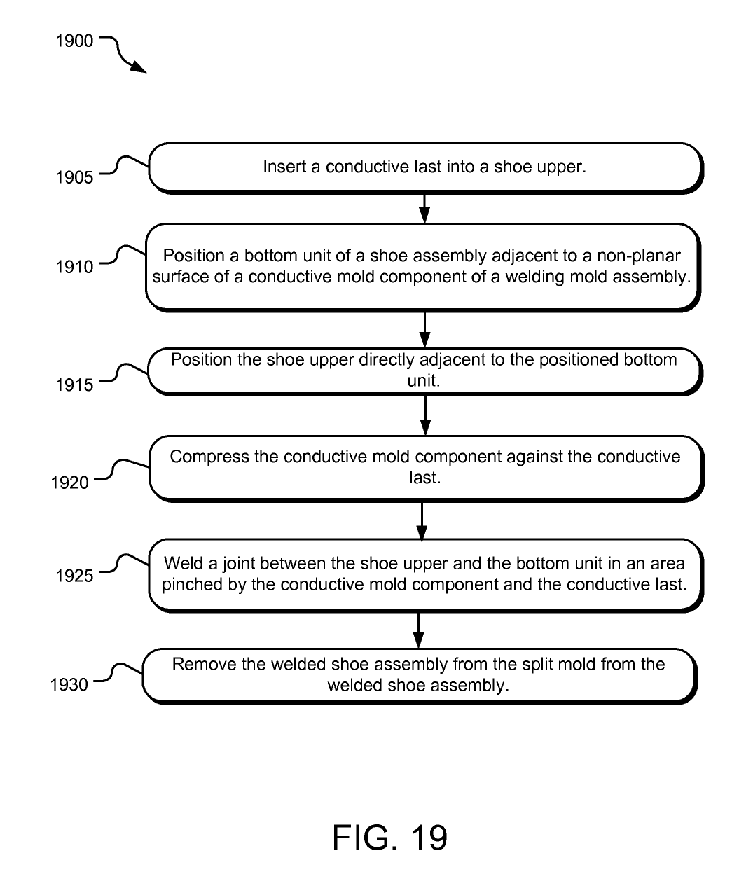

FIG. 19 illustrates example operations 1900 for three-dimensional welding of a shoe assembly. An insertion operation 1905 inserts a conductive last into a shoe upper. The shoe upper is formed to fit to a bottom unit at one or more contoured interface surfaces and provides an enclosure or other mechanism to fasten the shoe assembly to a user's foot. The last is a mechanical form that has a shape similar to that of the user's foot and approximates the user's foot during operations 1910-1925.

A positioning operation 1910 positions a bottom unit of a shoe assembly directly adjacent to a u-shaped conductive mold component of a welding mold assembly. The conductive mold component is sized and shaped to mate with (e.g., rest against) a corresponding perimeter surface of a conductive last. In one implementation, the conductive mold component is u-shaped and has a concave (e.g., tubular) outer surface designed to mate with an elongated convex groove running along a perimeter of the shoe upper. In other implementations, the conductive mold component is not u-shaped but is of another shape that provides support for a non-planar weldable surface of a shoe assembly.

The positioning operation 1910 positions the bottom unit (or a portion thereof) of the shoe assembly within a receiving area of the welding mold assembly such that a portion of the bottom unit is placed adjacent to and in contact with the conductive mold component. Once attached to the shoe upper, the bottom unit serves to engage the shoe assembly with the ground and to provide improved durability, traction, and/or cushioning to a user's foot.

Another positioning operation 1915 positions the shoe upper (with the last inserted therein) directly adjacent to the bottom unit that has been positioned within the welding mold assembly. A welding surface of the shoe upper faces the welding surface of the bottom unit.

A compression operation 1920 compresses the conductive mold component against the conductive last, thereby pinching a non-planar perimeter surface of the shoe upper directly against a non-planer perimeter region of the bottom unit (e.g., a desired welding area).

A welding operation 1925 welds a joint between shoe upper and the bottom unit in the region that is pinched between the conductive mold component and the conductive last. A variety of welding techniques may be used to accomplish the welding operation 1925 (e.g., RF welding and ultrasonic welding). A removing operation 1930 removes the welded shoe assembly from the split mold and the last from the welded shoe assembly.

The logical operations making up the embodiments of the invention described herein are referred to variously as operations, steps, objects, or modules. Furthermore, it should be understood that logical operations may be performed in any order, adding or omitting operations as desired, unless explicitly claimed otherwise or a specific order is inherently necessitated by the claim language.

The above specification, examples, and data provide a complete description of the structure and use of exemplary embodiments of the invention. Since many embodiments of the invention can be made without departing from the spirit and scope of the invention, the invention resides in the claims hereinafter appended. Furthermore, structural features of the different embodiments may be combined in yet another embodiment without departing from the recited claims.

What is claimed is:

1. A shoe assembly comprising:
a shoe upper; and
a bottom unit including a plastic surface welded to a plastic surface of the shoe upper.

2. The shoe assembly of claim 1, wherein the bottom unit includes a carrier and an array of cushioning elements attached thereto.

3. The shoe assembly of claim 2, wherein individual cushioning elements of the array of cushioning elements protrude through apertures in the carrier.

4. The shoe assembly of claim 2, wherein each of the cushioning elements includes multiple void cells.

5. The shoe assembly of claim 2, wherein each of the cushioning elements includes at least two interfacing void cells.

6. A method of assembling a shoe comprising:
compressing a shoe upper against a bottom unit between a conductive last and a conductive mold; and
applying an electrical signal to at least one of the conductive last and the conductive mold sufficient to weld the shoe upper to the bottom unit.

7. The method of claim 6, wherein the electrical signal is a radio-frequency (RF) signal.

8. The method of claim 6, wherein the electrical signal has a frequency substantially between 15 and 70 kilohertz (kHz).

9. The method of claim 6, wherein the bottom unit includes a carrier and a number of cushioning elements and the carrier further includes through-holes each sized and shaped to receive a portion of one of the cushioning elements.

10. The method of claim 9, further comprising:
positioning each of the cushioning elements within a corresponding one of the through-holes of the carrier.

11. The method of claim 9, further comprising:
positioning the carrier within the conductive mold.

12. The method of claim 9, further comprising:
positioning the conductive last within the shoe upper; and
positioning the shoe upper directly adjacent to the carrier and within the welding mold.

13. The method of claim 9, wherein each of the cushioning elements includes at least one elastically compressible void cell.

14. The method of claim 9, wherein each of the cushioning elements includes an array of void cells with at least two interfacing void cells.

15. The method of claim 6, wherein the conductive mold includes at least two conductive mold components configured to contact a same surface of the bottom unit.

16. A welding system comprising:
a electrically conductive mold sized and shaped to receive a bottom unit of a shoe assembly; and
a electrically conductive last sized and shaped for insertion into a shoe upper of the shoe assembly.

17. The welding system of claim 16, further comprising:
a transmitter electrically coupled to at least one of the electrically conductive mold and the electrically conductive last.

18. The welding system of claim 17, wherein the transmitter is an RF transmitter.

19. The welding system of claim 16, wherein the electrically conductive mold includes two mold components.

20. The welding system of claim 16, wherein the electrically conductive mold includes a number of indentations for receiving corresponding cushioning elements of the bottom unit.
